(19) United States
(12) Patent Application Publication
(10) Pub. No.: US 2004/0241059 A1
(43) Pub. Date: Dec. 2, 2004

(54) Reactor for oxidizing reaction of a liquid with a gas

(76) Inventors: Francois Seidlitz, Boeschepe (FR); Corinne Mathieu, Ternay (FR)

Correspondence Address: Jean-Louis Seugnet, Intellectual Property Dept , Rhodia, 259 Prospect Plains Road, CN 7500, Cranbury, NJ, 08512-7500, US

(21) Appl. No.: 10/492,287

(22) PCT Filed: Oct. 11, 2002
(86) PCT No.: PCT/FR02/03466

(30) Foreign Application Priority Data
Oct. 12, 2001 (FR) 01/13204

(51) Int. Cl. B01J 10/00; B01J 8/04

(52) U.S. Cl. 422/191; 422/188; 422/189

(57) ABSTRACT

The invention concerns a reactor (1) for oxidizing reaction of a liquid with a gas containing oxygen divided into stages (14) by separating plates (10). The means (5-8) feeding the reactor (1) with compound to be oxidized (E1) and oxidizing gas (E2) emerge solely at the base (2a) of the reactor (1), whereas the plates (10) are provided with passage holes (12) solely compatible with a unidirectional flow (E) of the reaction medium and designed to prevent gas accumulation beneath each of the plates (10).

The invention relates to a reactor suitable for an oxidation reaction of a liquid with a gas containing oxygen.

Such a reactor can be employed, for example, to oxidize cyclohexane during the preparation of intermediates of adipic acid, such as cyclohexyl hydroperoxide, cyclohexanol or cyclohexanone.

The oxidation of liquid cyclohexane with oxygen in air produces a mixture of cyclohexyl hydroperoxide (HPOCH), cyclohexanol (OL), cyclohexanone (ONE), and so-called “heavy” by-products.

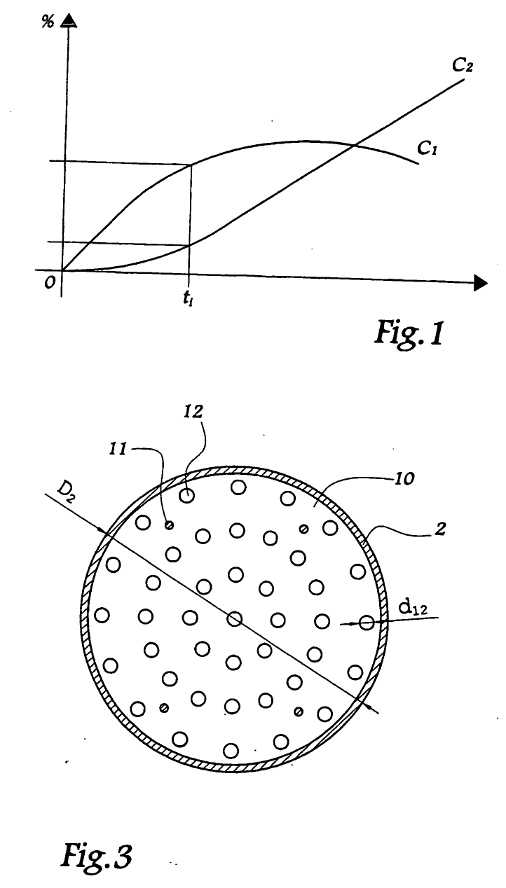

In this oxidation reaction involving a chain free-radical mechanism, the conversion rate as a function of time of the compound to be oxidized is kept at a low value to prevent the formation of by-products or undesirable products. For a reaction of this type, FIG. 1 shows the variation in the concentrations of desired product (C₁) and of by-products (C₂) as a function of time. To avoid an excessive degradation of the desired product into by-products, the aforementioned reaction is interrupted early, at a time tᵢ. This leaves a high proportion of compound to be oxidized that is recirculated to subject it to a new oxidation reaction.

To improve the selectivity of desired product of the aforementioned reaction, it is known that it is preferable to operate in a reactor of the “plug reactor” type, that is in a reactor which can be modelled like an enclosure in which a “slice” of reaction medium moves, in which the concentration of different products varies according to its position in the reactor, rather than in a “stirred” reactor in which the concentrations in the reaction medium are equal at all points to the exit concentrations. In the case of the “plug” reactor, the product concentration is only high near the reactor exit. Thus, the formation of undesirable by-products, which increases with the product concentration, is only significant in the terminal portion of the reactor.

In the known installations, the reaction is carried out in reactors, called “bubble columns”, in which the oxidizing gas is injected at the base, that is in the bottom portion, into the reaction medium. Above a certain diameter, it is known that these bubble columns can be considered as stirred reactors with respect to the reaction medium.

To improve the similarity with a “plug” reactor, the reactor can be divided into a plurality of unit reactors by means of internal separator plates preventing the recirculation of the reaction medium. In this case, it is known, for example from EP-A-0 135 718 or from U.S. Pat. No. 3,530,185, to provide distributed oxygen inlets to carry out an oxidation in each unit reactor. The quantity of oxygen introduced into each unit reactor must be accurately controlled so that nearly all the oxygen injected is consumed. This aims, for safety reasons, to avoid the presence of a gas blanket, rich in vapours of the compound to be oxidized and in oxygen, under one or a plurality of intermediate plates of the reactor. In fact, these vapours and the oxygen could form an explosive mixture under certain operating conditions. Such a staged feed must therefore be equipped with an elaborate control system, which significantly increases its cost. Furthermore, such a staged feed is cumbersome and difficult to operate industrially. Moreover, it requires the installation of complex piping.

The invention circumvents the routines of the technical field concerned by avoiding the use of a staged oxygen feed in a reactor divided into stages, but without overlooking the effective and necessary safeguarding of the installation.

For this purpose, the invention relates to a reactor for an oxidation reaction of a liquid with a gas containing oxygen, said reactor being fed exclusively at the base with a compound to be oxidized and an oxidizing gas. This reactor is characterized in that it is divided into stages by separator plates provided with slots compatible exclusively with a unidirectional flow of the reaction medium and able to prevent an accumulation of gas under each of the plates.

In a reactor of the invention, a single feed of oxidizing gas is provided, which enters in the bottom portion of the reactor, said feed delivering the oxygen which will be consumed in the different stages of the reactor. The oxidizing gas must therefore be able to circulate between these different stages, in the same way as the reaction medium, for example cyclohexane. In fact, given the temperatures and pressures obtaining in an industrial oxidation reactor, there could be a risk of autoignition of a gaseous mixture formed by the oxidizing gas and the vapours of the compound to be oxidized, said mixture possibly accumulating under certain plates to form a gas blanket, particularly during the deliberate or unintentional interruption of the feed of oxidizing gas.

Thanks to the invention, the perforations provided in this plate serve to eliminate any risk of formation of a gas blanket because the bubbles are removed through the aforementioned perforations. The perforations in the plates also serve to channel the two-phase flow inside the reactor, in a single direction, the upflow direction, thereby reducing its axial dispersion and serving to create a “plug” reactor type of flow.

These perforations also serve to limit the pressure drops caused by the plates.

According to the advantageous but not compulsory aspects of the invention, the aforementioned reactor incorporates one or a plurality of the following characteristics:

the perforations in the plates have a cross section equivalent to a circular section of diameter ranging between 10 and 100 mm, and preferably between 15 and 50 mm;

the plates present a perforation ratio ranging between 10 and 50% and preferably between 10 and 30%. This perforation ratio is the percentage of the areas of a plate corresponding to the perforations with respect to the total area of the plate;

the perforations are substantially equally distributed on the plates. In this case, they may be distributed with a triangular, rectangular or hexagonal base grid.

The invention also relates to the use of a reactor such as the one described above for the oxidation of hydrocarbons to different products such as hydroperoxide, ketone, alcohol and/or acid.

In a specific application, this reactor is used to oxidize cyclohexane by oxygen or air, to cyclohexyl hydroperoxide, cyclohexanone, cyclohexanol and/or adipic acid. Other uses of such a reactor can be envisaged, for example to oxidize cumene to phenol.

The invention can be better understood and other advantages thereof will appear more clearly in light of the description which follows of three embodiments of a reactor conforming to its principle, given only by way of example and made with reference to the appended drawings in which:

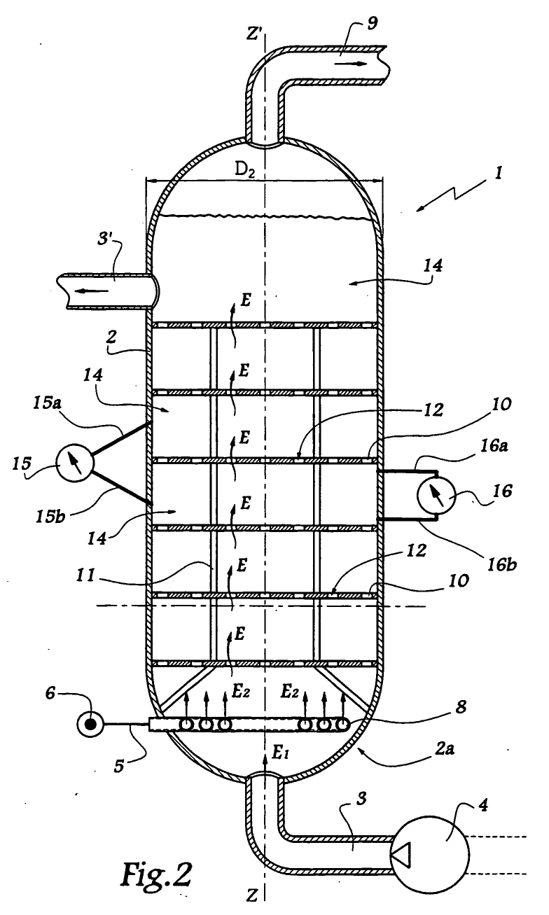

FIG. 2 is a schematic representation of a portion of an oxidation installation incorporating a reactor of the invention;

FIG. 3 is a cross section along line III-III of FIG. 2;

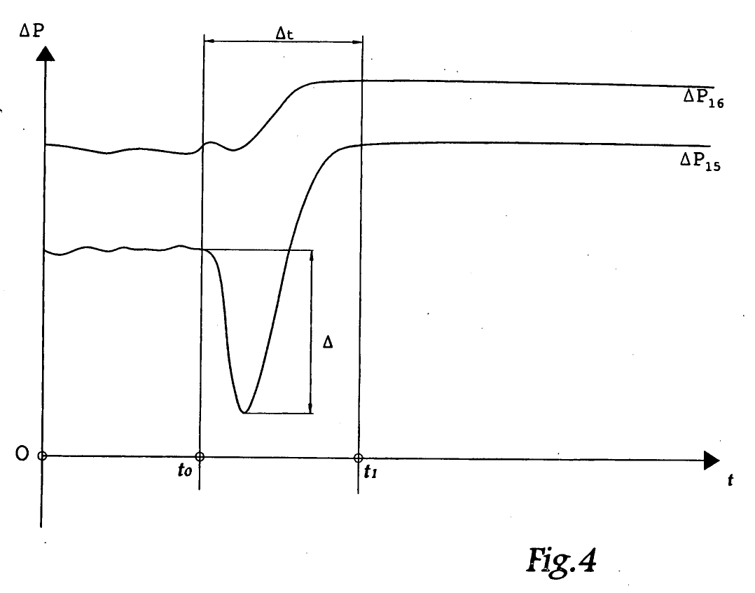

FIG. 4 is a schematic representation of the variation in the pressure differential between two levels in the reactor of FIG. 1, under certain operating conditions;

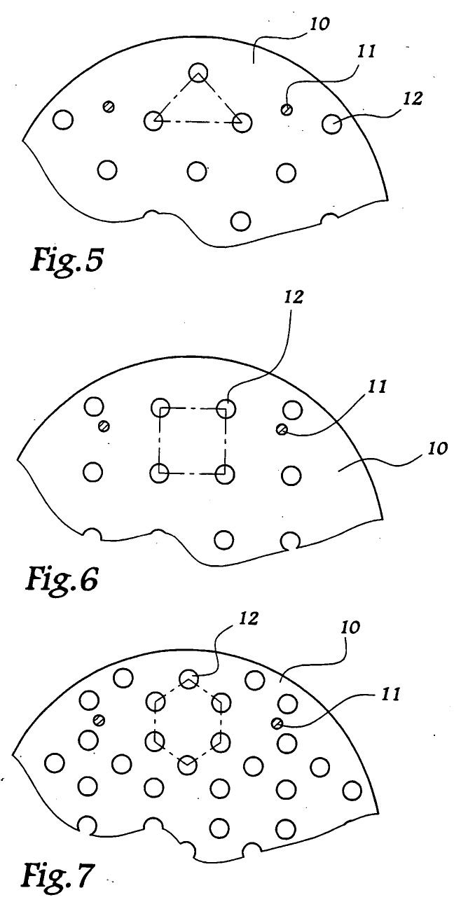

FIG. 5 is a partial schematic view of the plate shown in FIG. 3;

FIG. 6 is a view similar to FIG. 5, for a reactor according to a second embodiment of the invention and

FIG. 7 is a view according to FIG. 5, for a reactor according to a third embodiment of the invention.

The reactor 1 shown in these figures comprises a shell 2 in which terminates a feed duct 3 for the compound to be oxidized, for example cyclohexane, from a source (not shown).

A pump 4 is inserted in the duct 3 to convey the cyclohexane into the shell 2 at a controlled flow rate.

A second duct 3′ is provided in the upper portion of the shell 3 to remove the reaction medium.

An oxidizing gas feed system of the reactor 1 is provided and comprises a duct 5 connected to a pressurized air source 6. Oxidizing gas means oxygen or a gas containing oxygen, such as air or oxygen-enriched air.

The duct 5 terminates at the base of the shell 2, that is in the bottom portion of same, and is connected to a coil-shaped pipe 8 centred on a substantially vertical central axis Z-Z′ of the shell 2 and provided with perforations for the passage of air. As a variant, a plurality of pipes in the form of rings centred on the axis Z-Z′ could be employed.

A pipe 9 is provided at the top of the shell 2 to remove the gas phase consisting of gas coming from the oxidizing gas and vapours.

The arrow E₁ indicates the stream of cyclohexane in the bottom portion, or base, 2a of the shell 2. The arrows E₂ indicate the stream of oxidizing gas in this portion.

The reactor 1 is divided into stages by plates 10 kept at a distance from one another by means of spacer-rods 11. Other means for fixing the plates 10 in the shell 2 can be used.

Each plate 10 is provided with perforations 12 for the passage of the reaction medium and of the oxidizing gas, coming respectively from the duct 3 and the pipe 8.

The reactor can thus be divided into a plurality of stages 14 each constituting a unit reactor.

The reactor 1 must be secured against the malfunctions of its feed systems. For example, it must be designed to eliminate or to minimize the risks of autoignition of gas. Under the operating temperature and pressure conditions, cyclohexane vapour is created, and the mixture of cyclohexane vapours and oxygen can form an explosive mixture even without an ignition source. It is therefore essential to do everything possible to prevent the accumulation of such a gas mixture under the plates.

Furthermore, the pressure drops caused by the plates 10 must be as low as possible for the reasons stated above. In view of the foregoing, it is important for the perforations 12 to be as large as possible.

Moreover, the perforations 12 must not be too large in order to confer an upflow direction on the flow E of the two-phase mixture in the shell 2, without significant reflux of liquid from a higher stage 14 to a lower stage.

For the aforementioned reasons, the perforations 12 are therefore subject to contradictory constraints.

As to the safety aspect aimed at preventing the accumulation of gas under the plates 10, the concept of disengagement time Δt can be defined, which corresponds to the time needed to remove the gas between two predetermined levels of the reactor after interrupting the feed of oxidizing gas.

A differential pressure sensor 15 can be installed to measure the pressure difference on either side of a plate 10. The sensor 15 is connected by two branch lines 15a and 15b to two successive stages 14 of the reactor 1.

The sensor 15 can also measure the pressure difference across a plurality of plates 10, in which case it is connected to non-successive stages.

Moreover, a second differential pressure sensor 16 is connected by branch lines 16a and 16b to two points at different heights from the bottom of the shell 2, within the same stage 14.

The sensor 15 is used to measure the pressure drops across a plate 10 and the gas disengagement time across said plate. The sensor 16 is used to measure the gas holdup in a stage 14.

If the feed of cyclohexane and of oxidizing gas to the reactor 1 is stopped at a time t₀, the pressure difference ΔP₁₆ measured by the sensor 16 decreases, as shown in FIG. 4 by curve ΔP₁₆. Under the same conditions, the pressure difference ΔP₁₅ measured by the sensor 15 increases by a value Δ and then decreases. Δt denotes the time interval between the time t₀ and the time t₁ when ΔP₁₅ reaches its lower plateau value. Between the times t₀ and t₁, a transient phase occurs of disengagement of the gas present in the reactor 1.

By comparing the measurements taken in a reactor 1 equipped with plates 10 as shown in FIG. 2 and in a reactor without any plates, it is possible to determine the time lag in the gas disengagement caused by the plate or plates, which serves to compare this time lag with the limit imposed by the installation safety analysis.

In practice, considering circular-section perforations 12 of which the diameter d₁₂ ranges between 10 and 100 mm, the disengagement time Δt obtained is shorter than the time set by the installation safety analysis.

The diameter d₁₂ is chosen to be greater than 10 mm to ensure that any fouling of the perforations 12 does not cause a significant clogging of some or all of the perforations. The diameter d₁₂ is chosen to be less than 100 mm so that the flow in the perforations 12 remains unidirectional in the direction of the arrows E₁ and E₂ in FIG. 2, that is substantially vertical in the upflow direction.

Preferentially, the diameter d₁₂ is chosen to be between 15 and 50 mm, in which case the disengagement time is, surprisingly, substantially equivalent to that of a reactor without any plates. In other words, the plate or plates 10 of the reactor 1 of the invention do not hinder the unrestricted removal of the gas.

D₂ denotes the diameter of the shell 2.

The area A₁₀ of a plate 10 is equal to πD₂²/4. The area of a perforation 12 is equal to πd₁₂²/4.

N denotes the number of perforations 12 of a plate 10. The perforation ratio of a plate 10 is T=N×A₁₂/A₁₀=N×d₁₂²/d₂².

Owing to the value of the diameters d₁₂ and D₂, N is chosen so that the perforation ratio T ranges between 10 and 50%, and preferably between 10 and 30%. With such a perforation ratio, the flow E is essentially unidirectional and upflow in the shell 2, whereas, as indicated above, the pressure drops and the disengagement time remain compatible with safe industrial operation of an installation incorporating such a reactor.

The essentially unidirectional and upflow character of the flow E can be checked by the so-called “residence time distribution measurement” technique carried out by the injection of a tracer.

As shown in FIG. 5, the perforations 12 can be equally distributed in a substantially triangular grid. They can also be equally distributed in a substantially square grid, as shown in FIG. 6, or with a substantially hexagonal base grid, as shown in FIG. 7. Other geometrical distributions of the perforations 12 in the plates 10 can be considered.

The perforations 12 are not necessarily circular-section perforations, although such a cross section is favoured due to the ease of fabrication of the plates 10.

The plates 10 can take the form of plates of sufficient thickness to obtain a suitable mechanical strength, the perforations 12 being obtained by punching in the case of metal plates. The plates may be metallic, ceramic, or made of any other material suited to their operating conditions.

The invention has been described with reference to a cyclohexane oxidation reaction. However, it is not limited to this reaction and a reactor of the invention can be used in any oxidation reaction of a liquid by means of a gas containing oxygen and, in particular, for the oxidation of a hydrocarbon, for example the conversion of cumene to phenol.

1-10. (Canceled).

11. A reactor for an oxidization reaction of a liquid with a gas containing oxygen to obtain an oxidized compound, said reactor being fed exclusively at the base with a compound to be oxidized and an oxidizing gas, said reactor being divided into stages by separator plates (10) provided with perforations (12) compatible exclusively with a unidirectional flow (E) of the reaction medium and able to prevent an accumulation of gas under each of said plates.

12. The reactor according to claim 11, wherein said perforations (12) have a cross section equivalent to a circular section with diameter (d₁₂) ranging between 10 and 100 mm, and preferably between 15 and 50 mm.

13. The reactor according to claim 11, wherein said plates present a perforation ratio (T) ranging between 10 and 50%.

14. The reactor according to claim 13, wherein said ratio is ranging between 10 and 30%.

15. The reactor according to claim 11, wherein said perforations (12) are substantially equally distributed on said plates (10).

16. The reactor according to claim 11, wherein said perforations (12) are distributed in a triangular base grid.

17. The reactor according to claim 11, wherein said perforations (12) are distributed in a rectangular base grid.

18. The reactor according to claim 11, wherein said perforations (12) are distributed in a hexagonal base grid.

19. The reactor according to claim 11, wherein the compound to be oxidized is an hydrocarbon.

20. The reactor according to claim 19, wherein the oxidized compound is an hydroperoxide, ketone, alcohol or acid.

21. The reactor according to claim 19, wherein the hydrocarbon is cyclohexane, the oxidizing gas is oxygen or air, and the oxidized compound is cyclohexyl hydroperoxide (HPOCH), cyclohexanol (OL), cyclohexanone (ONE) or adipic acid.

22. The reactor according to claim 19, wherein the compound to be oxidized is cumene and the oxidized compound is phenol.
